(19) United States
(12) Patent Application Publication
(10) Pub. No.: US 2023/0122301 A1
(43) Pub. Date: Apr. 20, 2023

(54) DEVICE AND METHODS RELATING TO ANIMAL DETERRENT SYSTEMS

(71) Applicant: DENNIS MARTEL, ASHTON (CA)

(72) Inventor: DENNIS MARTEL, ASHTON (CA)

(21) Appl. No.: 17/967,515

(22) Filed: Oct. 17, 2022

Related U.S. Application Data
(60) Provisional application No. 63/262,601, filed on Oct. 15, 2021.

(51) Int. Cl. A01K 15/02

(52) U.S. Cl. CPC A01K 15/021

(57) ABSTRACT

Animal repellents or deterrents generally work by taking advantage of an animal's natural aversion to something. Animal deterrents are generally deployed in fixed locations to prevent damage to property etc. such as cottages, storage sheds, campsites etc. However, in many instances users such as walkers, hikers, hunters, postal workers or security guards, for example, may need access to an animal deterrent wherever they are. The inventor has established a portable animal deterrent system that provides a high intensity light (for user as either a torch or animal deterrent), the generation of loud noise, and inducement of pain through an electrical discharge to the animal's skin, and pain by using the device as a club. Further, simple control interfaces compatible with one handed operation allow the multiple modes and deterrents to be easily accessed and novel probes on the device allow penetration of an animal's fur.

### CROSS-REFERENCE TO RELATED APPLICATIONS

This patent application claims the benefit of priority to U.S. Provisional Patent Application 63/262,601 filed Oct. 15, 2021; the entire contents of which are incorporated herein by reference.

### FIELD OF THE INVENTION

This patent application relates to animal deterrent systems and more particularly methods and systems for controlling their activation and use.

### BACKGROUND OF THE INVENTION

Animal repellents generally work by taking advantage of an animal's natural aversion to something, and often the thing chosen is something that the animal has learned to avoid (or instinctively avoids) in its natural environment. This may be, for example, pain, intense light, or loud noise. Typical systems are generally deployed in fixed locations to prevent damage to property etc. such as cottages, storage sheds, campsites etc.

However, in many instances a user, such as walker, hiker, hunter, postal worker or security guard for example, may need access to an animal deterrent wherever they are. Accordingly, it would be beneficial to provide users with a portable animal deterrent system that provides for high intensity light (either as a torch or animal deterrent), generation of a loud noise, induces pain through an electrical discharge to the animal's skin, and inflicting pain through being used as a club.

It would be further beneficial for the portable animal deterrent to have simple control interfaces compatible with one handed operation allowing the multiple modes and deterrents to be easily accessed as well as probes on the device allowing penetration of an animal's fur.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to animal deterrent systems and more particularly methods and systems for controlling their activation and use.

In accordance with an embodiment of the invention there is provided an animal deterrent system comprising:

a body providing a user with a handle at one end and a deterrent element at a second distal end; wherein
the deterrent element comprises:
an optical source as a first deterrent; and
an electrical discharge generator for at least one of generating an acoustic signal as a second deterrent and an electrical discharge into a body of an animal as a third deterrent.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a schematic of an animal deterrent system (ADS) according to an embodiment of the invention;

FIG. 2A depicts a perspective view of an ADS according to an embodiment of the invention;

FIG. 2B depicts a detail of a control section of an ADS according to an embodiment of the invention;

FIG. 3 depicts an electrical discharge assembly and light element for an ADS according to an embodiment of the invention;

FIG. 4 depicts a carrying tube according to an embodiment of the invention for an ADS according to an embodiment of the invention;

FIG. 5 depicts a control and function flowchart for an ADS according to an embodiment of the invention employing dual push button controls with no delay;

FIG. 6 depicts a control and function flowchart for an ADS according to an embodiment of the invention employing dual push button controls

FIG. 7 depicts a control and function flowchart for an ADS according to an embodiment of the invention employing a rocker switch; and

FIG. 8 depicts a control and function flowchart for an ADS according to an embodiment of the invention employing a single push button control.

### DETAILED DESCRIPTION

The present invention is direct to animal deterrent systems and more particularly methods and systems for controlling their activation and use.

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including”, “comprising”, “consisting” and grammatical variants thereof do not preclude the addition of one or more components, features, steps, integers or groups thereof and that the terms are not to be construed as specifying components, features, steps or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

A “wireless standard” as used herein and throughout this disclosure, refer to, but is not limited to, a standard for transmitting signals and/or data through electromagnetic radiation which may be optical, radio-frequency (RF) or microwave although typically RF wireless systems and techniques dominate. A wireless standard may be defined globally, nationally, or specific to an equipment manufacturer or set of equipment manufacturers. Dominant wireless standards at present include, but are not limited to IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, Bluetooth, Wi-Fi, Ultra-Wideband and WiMAX. Some standards may be a conglomeration of sub-standards such as IEEE 802.11 which may refer to, but is not limited to, IEEE 802.1a, IEEE 802.11b, IEEE 802.11g, or IEEE 802.11n as well as others under the IEEE 802.11 umbrella.

A “wired standard” as used herein and throughout this disclosure, generally refer to, but is not limited to, a standard for transmitting signals and/or data through an electrical cable discretely or in combination with another signal. Such wired standards may include, but are not limited to, digital subscriber loop (DSL), Dial-Up (exploiting the public switched telephone network (PSTN) to establish a connection to an Internet service provider (ISP)), Data Over Cable Service Interface Specification (DOCSIS), Ethernet, Gigabit home networking (G.hn), Integrated Services Digital Network (ISDN), Multimedia over Coax Alliance (MoCA), and Power Line Communication (PLC, wherein data is overlaid to AC/DC power supply). In some embodiments a “wired standard” may refer to, but is not limited to, exploiting an optical cable and optical interfaces such as within Passive Optical Networks (PONs) for example.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, a wearable device and an electronic reader.

A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

A “wearable device” or “wearable sensor” relates to miniature electronic devices that are worn by the user including those under, within, with or on top of clothing and are part of a broader general class of wearable technology which includes “wearable computers” which in contrast are directed to general or special purpose information technologies and media development. Such wearable devices and/or wearable sensors may include, but not be limited to, smartphones, smart watches, e-textiles, smart shirts, activity trackers, smart glasses, environmental sensors, medical sensors, biological sensors, physiological sensors, chemical sensors, ambient environment sensors, position sensors, neurological sensors, drug delivery systems, medical testing and diagnosis devices, and motion sensors.

A “sensor” as used herein may refer to, but is not limited to, a transducer providing an electrical output generated in dependence upon a magnitude of a measure and selected from the group comprising, but is not limited to, environmental sensors, medical sensors, biological sensors, chemical sensors, ambient environment sensors, position sensors, motion sensors, thermal sensors, infrared sensors, visible sensors, RFID sensors, and medical testing and diagnosis devices.

A “user” as used herein may refer to, but is not limited to, an individual or group of individuals. This includes, but is not limited to, private individuals, employees of organizations and/or enterprises, members of community organizations, members of charity organizations, men and women. In its broadest sense the user may further include, but not be limited to, software systems, mechanical systems, robotic systems, android systems, etc. that may be characterised by an ability to exploit one or more embodiments of the invention. A user may be associated with biometric data which may be, but not limited to, monitored, acquired, stored, transmitted, processed and analysed either locally or remotely to the user. A user may also be associated through one or more accounts and/or profiles with one or more of a service provider, third party provider, enterprise, social network, social media etc. via a dashboard, web service, website, software plug-in, software application, and graphical user interface.

“Biometric” information as used herein may refer to, but is not limited to, data relating to a user characterised by data relating to a subset of conditions including, but not limited to, their environment, medical condition, biological condition, physiological condition, chemical condition, ambient environment condition, position condition, neurological condition, drug condition, and one or more specific aspects of one or more of these said conditions. Accordingly, such biometric information may include, but not be limited, blood oxygenation, blood pressure, blood flow rate, heart rate, temperate, fluidic pH, viscosity, particulate content, solids content, altitude, vibration, motion, perspiration, EEG, ECG, energy level, etc. In addition, biometric information may include data relating to physiological characteristics related to the shape and/or condition of the body wherein examples may include, but are not limited to, fingerprint, facial geometry, baldness, DNA, hand geometry, odour, and scent. Biometric information may also include data relating to behavioral characteristics, including but not limited to, typing rhythm, gait, and voice.

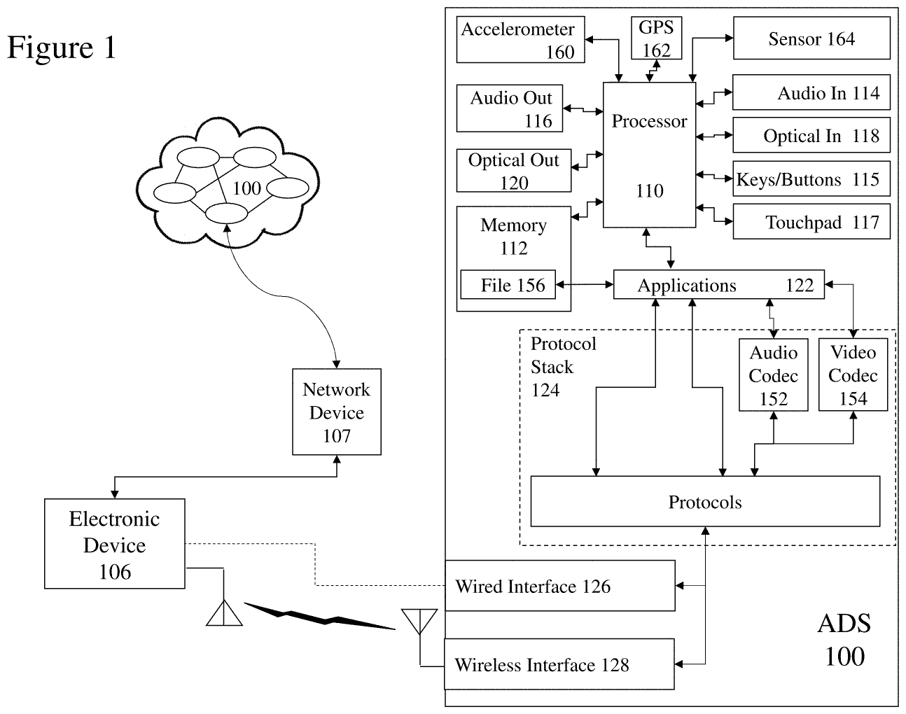

FIG. 1 depicts a schematic of an animal deterrent system (ADS) 104 according to an embodiment of the invention. Also depicted in conjunction with the ADS 100 are exemplary internal and/or external elements forming part of a simplified functional diagram of an ADS 100 within an overall simplified schematic of a system supporting communications, configuration, etc. for the ADS. As depicted the ADS 100 has a Wireless Interface 128 and a Wired Interface 126. Wired Interface 126 may provide data communications to/from the ADS as well as electrical power. Optionally Wired Interface 126 may be two or more wired interfaces without departing from the scope of the invention such that one interface provides DC power whilst another supports data communications. Optionally, Wireless Interface 128 may be a single interface supporting a single wireless protocol or it may be two or more wireless interfaces. Accordingly, the ADS 100 may communicate with an Electronic Device 106 and therein to a Network Device 107 and a telecommunications Network 100. Optionally, ADS 100 may also support optical communications to Electronic Device 106. Within embodiments of the invention the Electronic Device 106 may be a PED, FED, Wearable Device etc.

According to embodiments of the invention the ADS 100 may communicate with the Electronic Device 106 via one or more wireless or wired interfaces which may be selected from the group comprising IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC). As such the ADS 100 may as outlined below be configured via Electronic Device 106 via a user of the ADS 100 or an original equipment manufacturer (OEM) of the ADS 100 etc. The ADS 100 may as outlined below be configured to communicate data to the Electronic Device 106 for a user of the ADS 100 or communicate data to an OEM of the ADS 100, a service provider, a third party service provider, a regulatory authority, a regulator, a Government organization, law enforcement etc.

The ADS 100 includes one or more Processor 110 and a Memory 112 coupled to Processor(s) 110. A non-exhaustive list of examples for Processor 110 includes a central processing unit (CPU), a digital signal processor (DSP), a reduced instruction set computer (RISC), a complex instruction set computer (CISC) and the like. Furthermore, Processor 110 may be part of application specific integrated circuits (ASICs) or may be a part of application specific standard products (ASSPs). A non-exhaustive list of examples for Memory 112 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

ADS 100 may include an Audio Input element 114, for example a microphone, and an Audio Output element 116, for example, a speaker, coupled to Processor 110. ADS 100 may include an Optical Input element 118, for example, a video camera or camera, and an Optical Output element 120, for example an LCD display, coupled to any of Processor 110. ADS 100 also includes one or more Keys/Buttons 115 and Touchpad 117 the user to enter content or select functions within one of more Applications 122 of the ADS. Alternatively, the Keys/Buttons 115 and Touchpad 117 may be predetermined regions of a touch sensitive element forming part of the display within the ADS 100. The one or more Applications 122 that are typically stored in Memory 112 and are executable by Processor 110. ADS 100 also includes an Accelerometer 160 providing three-dimensional motion input to the Processor 110, GPS 162 which provides geographical location information to Processor 110, and Sensor 164 which provides sensor data to the Processor 110.

In order to support communications to or from the ADS 100 via the Wired Interface 126 and/or Wireless Interface 128 the ADS 100 includes a Protocol Stack 124 which supports all the requirements of communications. Protocol stack 224 includes additional modules such as presentation layer media negotiation and call control, for example, to support communications as well as one or more Audio Codecs 152 and one or more Video Codecs 154. Applications 122 may be able to create maintain and/or terminate communication sessions with one or more Electronic Device 106 and therein to Network Device(s) 107 and remote devices via the Telecommunications Network 100.

The Wireless Antenna 128 wirelessly connects the ADS 100 with the Electronic Device 106, wherein the ADS 100 may support, for example, a national wireless standard such as GSM together with one or more local and/or personal area wireless protocols such as IEEE 802.11 a/b/g Wi-Fi, IEEE 802.16 WiMAX, and IEEE 802.15 Bluetooth for example. Accordingly, it would be evident to one skilled in the art that the ADS 100 may accordingly download original software and/or revisions for a variety of functions. In some embodiments of the invention the functions may not be implemented within the original as sold ASD and are only activated through a software/firmware revision and/or upgrade either discretely or in combination with a subscription or subscription upgrade for example. Accordingly, as will become evident the ADS 100 may provide the user with access to one or more software services and application platforms (SSAPs) including, but not limited to, software installed upon the ADS 100 or upon one or more remote systems to which the ADS 100 can connect via the Telecommunications Network such as social networks/social media; remote systems; websites; service providers; third party service provides; regulators; law enforcement; etc. as well as remote servers.

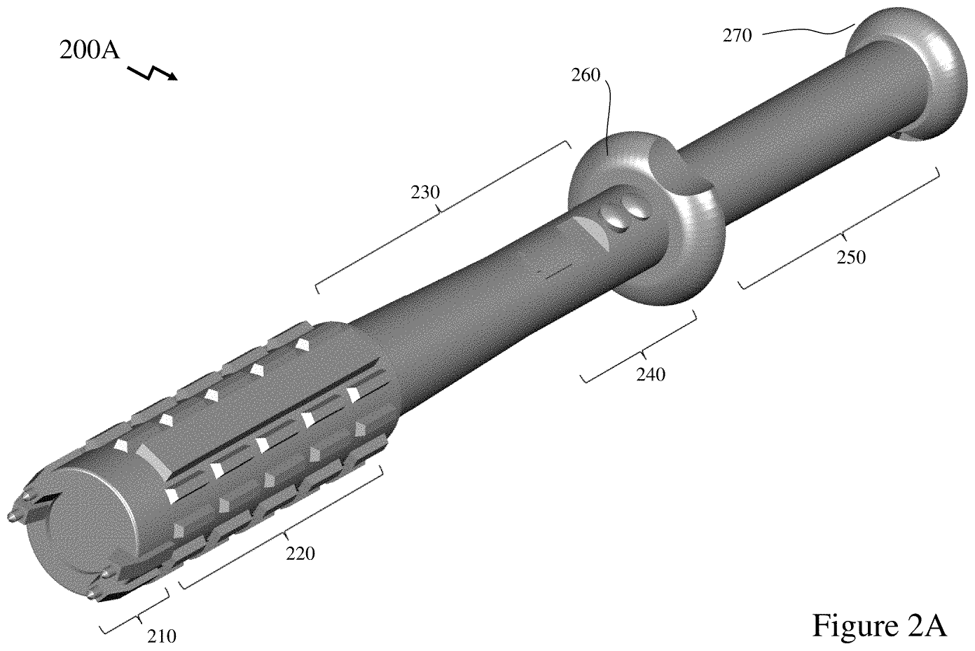

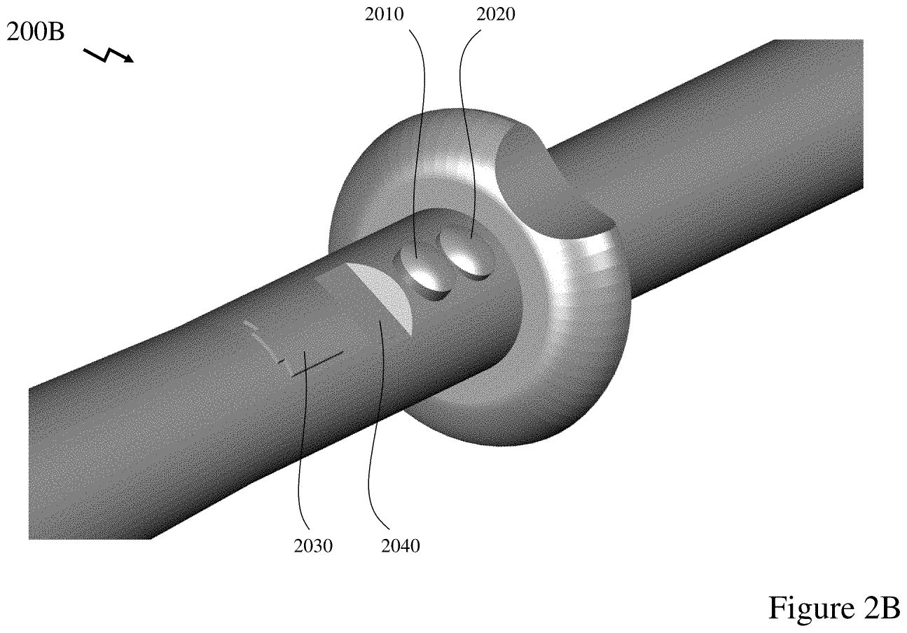

FIG. 2A depicts a perspective view of an animal deterrent system (ADS) 200A according to an embodiment of the invention. As depicted the ADS 200A comprises a Handle 250 with a Pommel 270, a main Body 230 which is separated from the Handle 250 by Hilt 260. The main Body 230 includes Interface Region 240 which provides the buttons, keys, displays, indicators for the user of the ADS 200A. At the distal end of the main Body 230 to the Hilt 260 is Head 220 to which the Discharge Assembly 210 is attached. The Head 220 as depicted comprising a geometrical pattern of raised elements on a cylindrical body wherein the Head 220 is weighted allowing the ADS 200A to function as a club in the event of the other means of deterrents of the ADS 200A not being effective or the internal power supply (e.g., one or more batteries) are exhausted. Optionally, within other embodiments of the invention a subset of the geometrical pattern of raised elements on the Head 220 may be additional light sources, e.g. additional LEDs allowing the ADS 200A to act as a lantern (e.g. using white LEDs) or as a direction indicator/signaling device wherein coloured LEDs (e.g. red/green) are selectively enabled under user control through the Interface Region 240 or from a PED or Wearable Device when the ADS is connected to PED or Wearable Device via a wired and/or wireless interface of the ADS 200A.

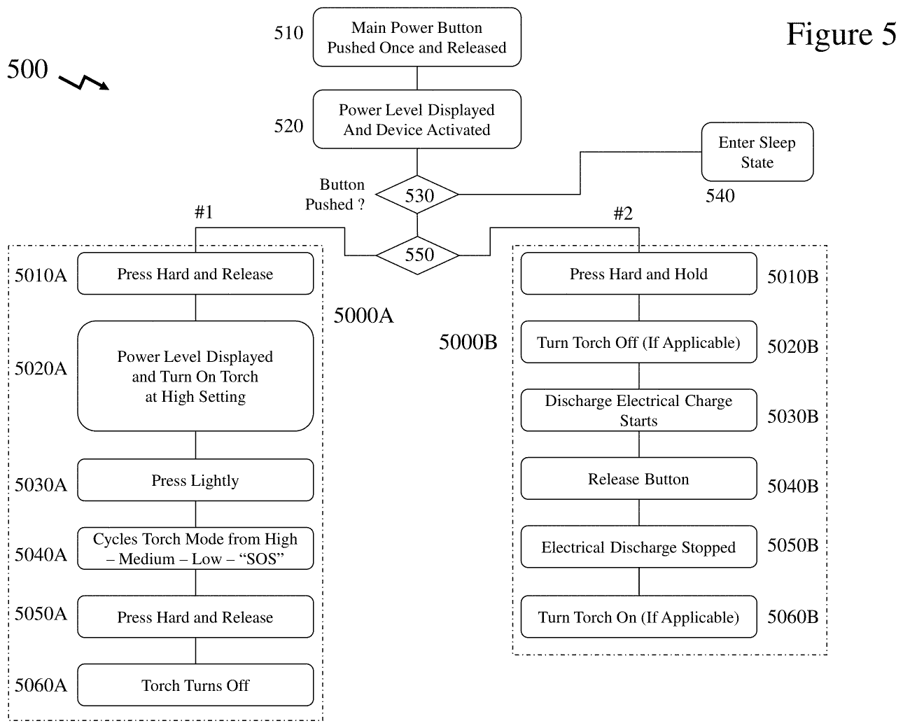

FIG. 2B depicts a detail of a control section, Interface Region 240, of an ADS 200B according to an embodiment of the invention. As depicted, there are first Button 2010, second Button 2020, Wired Interface 2030 and Display 2040. Accordingly, first and second Buttons 2010 and 2020 respectively may form part of the Keys/Buttons 115 of the ADS 100 in FIG. 1. Similarly, Wired Interface 2030 may be one of the Wired Interfaces 116 of the ADS 100 in FIG. 1 whilst Display 240 may be Optical Out 120 of ADS 100 in FIG. 1. As described below in respect of FIGS. 5 to 8 the ADS 200B may employ a pair of buttons, a single button, and a rocker switch. However, it would be evident that the ADS may employ more buttons, switches rather than buttons, or a touch sensitive input. Optionally, the ADS may include a biometric sensor such that only an authorised individual can activate the ADS.

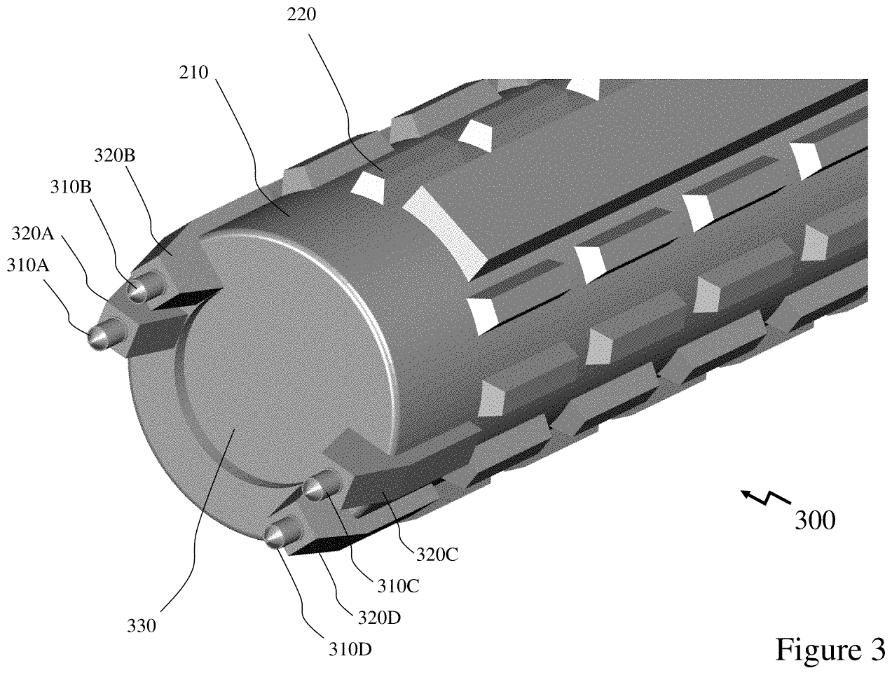

FIG. 3 depicts the Discharge Assembly 210 of an ADS 300 outlining the electrical discharge elements and light element for an ADS according to an embodiment of the invention. The Discharge Assembly 210 is disposed on the end of the ADS 300 distal to the Pommel 270 as depicted in FIG. 2A such that the Discharge Assembly 210 is furthest from the user when holding the Handle 250 and hence closest to the animal they are seeking to deter. Disposed within the end of the Discharge Assembly 210 is Lamp 330 which provides an illumination source which can act as a deterrent, such as when set to a high intensity output, or as a torch, such as when set to a low or medium intensity output. Disposed around the periphery of the Discharge Assembly 210 are four discharge elements in two pairs. Accordingly, there are depicted first to fourth Discharge Tips 310A to 310D which are atop first to fourth Discharge Mounts 320A to 320D, respectively. In this manner the first to fourth Discharge Tips 310A to 310D are furthest from the user of the ADS and closest to the animal they are seeking to deter. As discussed below for operating the ADS a high voltage electrical discharge can be applied to the animal via the first to fourth Discharge Tips 310A to 310D in order to deter it, shock it, stun it etc.

The first to fourth Discharge Tips 310A to 310D can penetrate through hair on the animal to the animal's skin. Within embodiments of the invention the length of the first to fourth Discharge Tips 310A to 310D from the first to fourth Discharge Mounts 320A to 320D respectively may be 5 mm, 6 mm, 7.5 mm, 12 mm, 18 mm, or 25 mm for example (approximately 0.2″, 0.25″, 0.3″, 0.5″, 0.7″, 1″). Within other embodiments of the invention other lengths may be employed as well as different numbers of discharge tips, different number of discharge tips per discharge tip grouping and different numbers of discharge tips. The inventor establishing this design for enhanced penetration of fur, hair etc. and contact with the animals skin. Optionally, the tips may be sharper such that forced insertion of the tips can be undertaken causing the animal pain.

The electrical discharge also generates noise. Within embodiments of the invention the noise generated can exceed 90 dB, 95 dB or 100 dB.

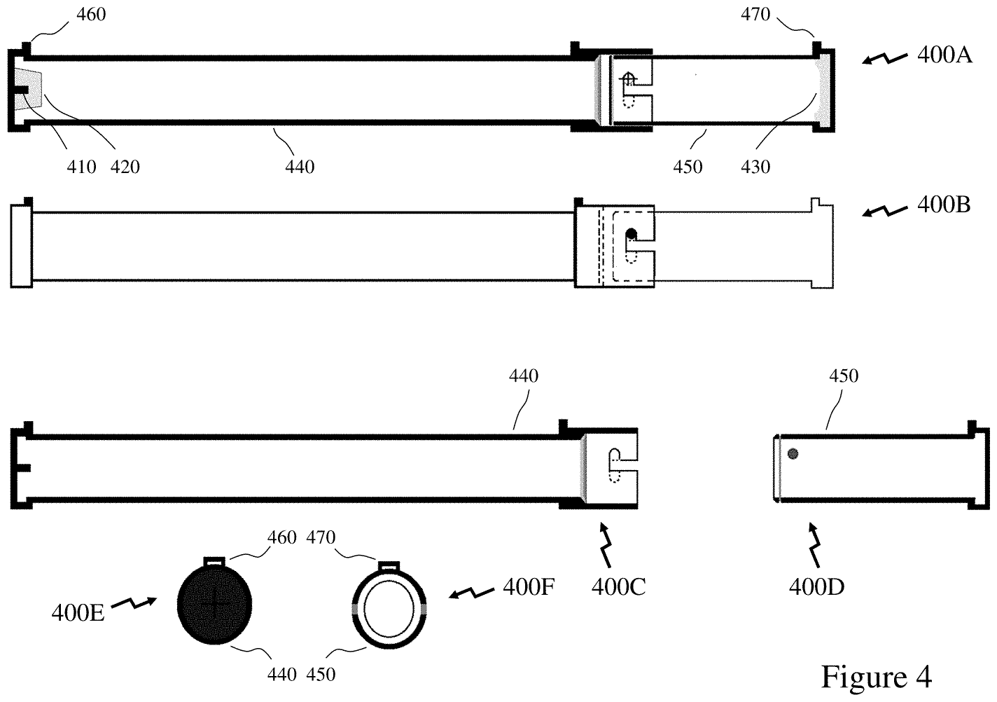

FIG. 4 depicts a Carrier Tube according to an embodiment of the invention for an ADS according to an embodiment of the invention. First Image 400A depicts a cross-section of the assembled Carrier Tube, second Image 400B an external view of the assembled Carrier Tube, third image 400C the body of the Carrier Tube, fourth Image 400D the cover of the Carrier Tube, with fifth and sixth images 400E and 400F depicting end views of the body and the cover of the Carrier Tube. The Carrier Tube depicted in FIG. 4 being designed to fit an ADS 200A as depicted in FIG. 2A. However, it would be evident that the principles described may be applied to other carrier tubes designed to fit other ADS geometries.

Referring to first and fifth Images 400A and 400E respectively a first Strap Mount 460 is depicted at a distal end of the Body 440 of the Carrier Tube whilst a second Strap Mount 470 as depicted in first and sixth Images 400A and 400F is depicted at a distal end of the Cover 450 of the Carrier Tube. A strap may be attached to the first and second Strap Mounts 460 and 470 allowing a user to carry the ADS within the Carrier Tube over their shoulder, strapped to an all-terrain vehicle (ATV), etc. As the head of the ATS is heavy then the Carrier Tube when slung over the user's shoulder would hang with the end of the Body 440 of the Carrier Tube with first Strap Mount 460 lowermost such that when the user undoes the cover of the Carrier Tube the handle end is disposed towards them. As depicted a twist and mount assembly for the Cover 450 to the Body 440 is employed for rapid removal when necessary but preventing accidental removal of the Cover 450.

Referring to first Image 400A disposed at the end of the Body 440 distal to its opening where the Cover 450 attaches within the Body 440 are first Foam 420 and Rigid Member 410 whilst disposed at the end of the Cover 450 distal to its opening where the Cover 450 attaches within the Body 440 is second Foam 420. First Foam 410 and second Foam 420 are designed to compress when the ADS is inserted into the Body 440 and the Cover 450 attached so that the ADS does move along the length of the Carrier Tube. Rigid Member 410 is intended to fit between each pair of Discharge Mounts, such as first and second Discharge Mounts 320A and 320B on one side of the ADS and third and fourth Discharge Mounts 320C and 320D on the other side of the ADS. In this manner, the ADS is further prevented from rotating. Optionally, two or more Rigid Members may be employed to increase the ease of assembling the Carrier Tube with the ADS or to engage with additional pairs of Discharge Mounts etc.

Further, the inner diameter of the Body 440 is designed to be approximately equal to or slightly less than the outer dimensions of the ADS such that the ADS has an interference fit to the Body 440 of the Carrier Tube. In this manner, with the Cover 450 removes the ADS cannot simply fall out of the Body 440 of the Carrier Tube but must be pulled by the user. These features being to prevent accidental release of the ADS from the Carrier Tube. Further, the external colour and pattern of the Carrier Tube would typically be bright yellow/orange to avoid any issues for the user being identified by law enforcement as carrying a concealed weapon as may occur in some jurisdictions.

Now referring to FIG. 5 there is depicted a control and function Flow 500 for an ADS according to an embodiment of the invention employing dual push button controls with no delay. Flow 500 being an example of a control and function flowchart for an ADS according to an embodiment of the invention with dual button control. According, Flow 500 begins at first step 510 wherein a user pushes the main power button of the ADS and releases it. The ADS then in second step 520 displays the power level of the ADS so the user can ascertain their ability to employ the ADS as a torch and/or deterrent. This may be, a percentage of full charge indicator, a projected torch lifetime in minutes, hours etc., a projected number of discharges, etc. or a combination thereof. In third step 530 the ADS determines whether the user pushes another button or not where if no further button push is established, e.g., after a predetermined period of time, the user proceeds to fourth step 540 and turns back off or enters a sleep state for a further predetermined period of time before turning off If one of the two push button controls is pushed the Flow 500 proceeds to fifth step 550 wherein it determines whether the first push button or second push button were pushed wherein it proceeds to either the first Sub-Flow 5000A or second Sub-Flow 5000B respectively relating to the torch functionality and deterrent functionalities, respectively.

In first Sub-Flow 5000A the ADS executes sixth to eleventh steps 5010A to 5060A respectively, these comprising:
Sixth step 5010A wherein the user presses hard on the first button and releases it;
Seventh step 5020A wherein the power level is again displayed and the torch is turned on at its highest setting;
Eighth step 5030A where further light presses of the user's finger are detected;
Ninth step 5040A where the further light presses of the user's finger are converted to sequential cycling through a series of illumination states of the torch, such as, for example, high, medium, low, and “SOS” where the torch emits S O S in visual Morse code;
Tenth step 5050A wherein a further hard press of the button is detected; and
Eleventh step 5060A wherein the ADS turns off the torch function in response to the hard press detected in tenth step 5050A.

Eighth and ninth steps 5030A and 5040A may be repeated multiple times until the user turns the torch off.

In second Sub-Flow 5000B the ADS executes twelfth to seventeenth steps 5010B to 5060B respectively, these comprising:
Twelfth step 5010B wherein the user presses on the second button hard;
Thirteenth step 5020B wherein the ADS turns off the torch if on;
Fourteenth step 5030B wherein the ADS discharges electrically to the Discharge Tips whilst the user holds the second button;
Fifteenth step 5040B wherein the user releases the button;
Sixteenth step 5050B wherein the ADS ceases the electrical discharge; and
Seventeenth step 5060B turns the torch on, if applicable.

Optionally, the first button and second button may be discrete from the main power button or within other embodiments of the invention one of the first power button and second power button may be main power button. Optionally, the second Sub-Flow 5000B may turn on the torch at predetermined illumination in seventeenth step 5060B independent of any configuration of the torch previously made by the user.

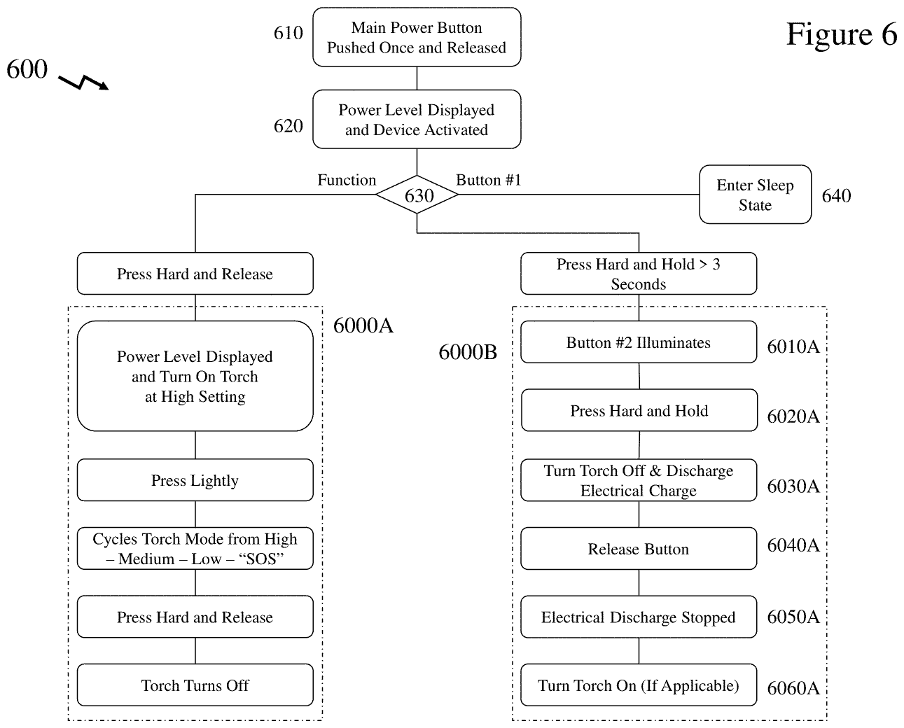

Referring to FIG. 6, there is depicted a control and function Flow 600 for an ADS according to an embodiment of the invention employing dual push button controls. Flow 600 being an example of a control and function flowchart for an ADS according to an embodiment of the invention with dual button control. According, Flow 600 begins at first step 610 wherein a user pushes the main power button of the ADS and releases it. The ADS then in second step 620 displays the power level of the ADS so the user can ascertain their ability to employ the ADS as a torch and/or deterrent. This may be, a percentage of full charge indicator, a projected torch lifetime in minutes, hours etc., a projected number of discharges, etc. or a combination thereof. In third step 630 the ADS determines whether the user's action with respect to another button. If no action is undertaken with the other button, e.g., after a predetermined period of time, the user proceeds to fourth step 640 and turns back off or enters a sleep state for a further predetermined period of time before turning off. If the user presses the other button hard and releases it the ADS executes first Sub-Flow 6000A. If the user presses the other button hard for at least three seconds (although other time thresholds may be set, e.g., 2 seconds, 5 seconds, or other control sequences may also be employed without departing from the scope of the invention) then the process proceeds to second Sub-Flow 6000B. The first Sub-Flow 6000A and second Sub-Flow 6000B respectively relating to the torch functionality and deterrent functionalities, respectively.

As depicted first Sub-Flow 6000A comprises the same sequence of steps as first Sub-Flow 5000A in FIG. 5. Second Sub-Flow 6000B comprises fifth to tenth steps 6010A to 6060A, these comprising:
Fifth step 6010A wherein a second button of the ADS is illuminated;
Sixth step 6020A wherein the user presses on the second button hard;
Seventh step 6030A wherein the ADS turns off the torch if it was one and discharges electrically to the Discharge Tips whilst the user holds the second button;
Eighth step 6040A wherein the user releases the button;
Ninth step 6050A wherein the ADS ceases the electrical discharge; and
Tenth step 6060A turns the torch on, if applicable.

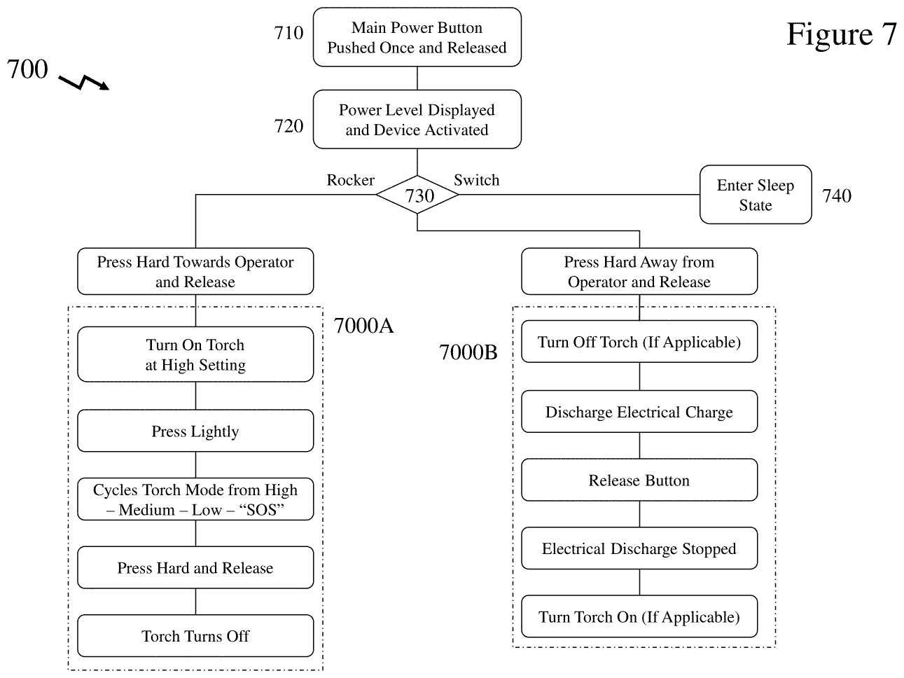

Now referring to FIG. 7 there is depicted a control and function Flow 700 for an ADS according to an embodiment of the invention employing a rocker switch. According, Flow 700 begins at first step 710, wherein a user pushes the main power button of the ADS and releases it. The ADS then in second step 720 displays the power level of the ADS so the user can ascertain their ability to employ the ADS as a torch and/or deterrent. This may be, a percentage of full charge indicator, a projected torch lifetime in minutes, hours etc., a projected number of discharges, etc. or a combination thereof. In third step 730 the ADS determines the user's action with respect to the rocker switch. If no action is undertaken with the other button, e.g., after a predetermined period of time, the user proceeds to fourth step 740 and turns back off or enters a sleep state for a further predetermined period of time before turning off. If the user presses the rocker switch hard towards the user and releases it then the ADS executes first Sub-Flow 7000A. If the user presses the rocker switch hard away from themselves and releases it then the process proceeds to second Sub-Flow 7000B. The first Sub-Flow 7000A and second Sub-Flow 7000B respectively relating to the torch functionality and deterrent functionalities, respectively. First Sub-Flow 7000A comprises the same sequence of steps as first Sub-Flow 5000A in FIG. 5. Second Sub-Flow 6000B comprises the same sequence as thirteenth to seventeenth steps 5020B to 5060B of second Sub-Flow 5000B in FIG. 5.

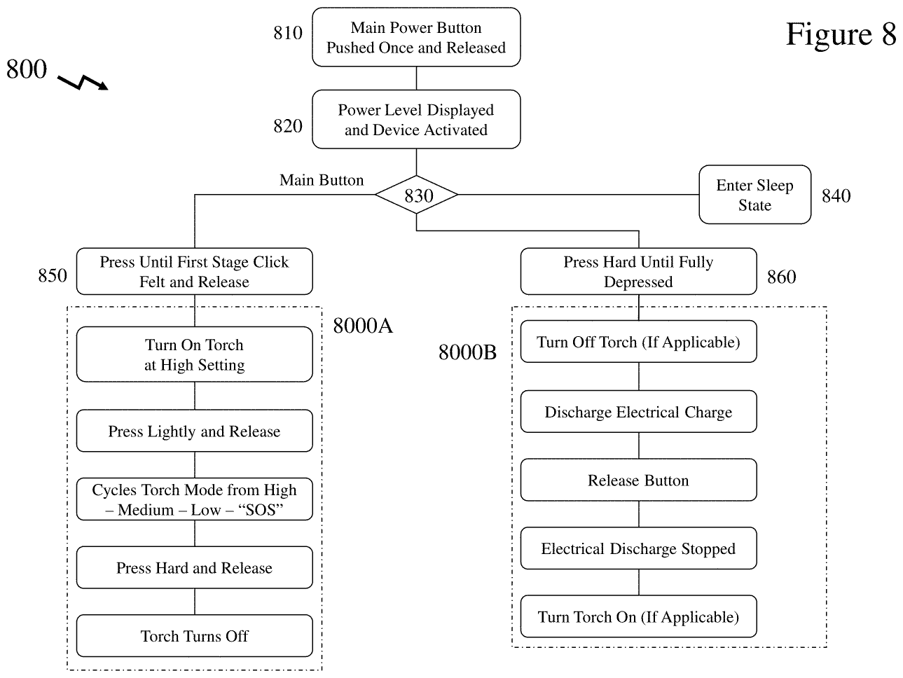

Referring to FIG. 8, there is depicted a control and function Flow 800 for an ADS according to an embodiment of the invention employing a single push button control. According, Flow 800 begins at first step 810 wherein a user pushes the main power button of the ADS and releases it. The ADS then in second step 820 displays the power level of the ADS so the user can ascertain their ability to employ the ADS as a torch and/or deterrent. This may be, a percentage of full charge indicator, a projected torch lifetime in minutes, hours etc., a projected number of discharges, etc. or a combination thereof. In third step 830 the ADS determines the user's action with respect to the single push button of the ADS. If no action is undertaken with the other button, e.g., after a predetermined period of time, the user proceeds to fourth step 840 and turns back off or enters a sleep state for a further predetermined period of time before turning off. If the user presses the button until a first stage click point is reached (which the button presents to the user as a click they can feel) and releases it then the ADS executes first Sub-Flow 8000A. If the user presses the button hard past the first stage click point until it is fully depressed then the process proceeds to second Sub-Flow 8000B. In this instance no release of the button is required but may be required in other embodiments of the invention. The first Sub-Flow 8000A and second Sub-Flow 8000B respectively relating to the torch functionality and deterrent functionalities, respectively. First Sub-Flow 8000A comprises the same sequence of steps as first Sub-Flow 5000A in FIG. 5. Second Sub-Flow 8000B comprises the same sequence as thirteenth to seventeenth steps 5020B to 5060B of second Sub-Flow 5000B in FIG. 5.

Whilst the torch function has been defined as offering three levels of illumination together with “SOS”, high, medium and low, it would be evident that less or more levels may be provided without departing from the scope of the invention. Further, within embodiments of the invention continued closure of a button may cycle the power from an upper limit to a lower limit in a series of steps, e.g., 4, 8, 16 etc., or cycle it from an upper level to lower or vice-versa and then back towards the original level.

Within an embodiment of the invention the electrical discharge is sufficient to result in breakdown of the air and the emission of a loud noise. Optionally, other electrical discharge potentials may be generated for applying a shock to an animal with or without them generating an electrical discharge prior to contact or in absence of contact with the animal. The potential required being defined by the separation of the Discharge Elements and the humidity etc. of the air but typically a field of 3 kV/mm is required. Within embodiments of the invention the electrical discharge is >50,000V (50 kV) with a tip separation of 10 mm so that even in dry air the breakdown occurs generating noise in excess of 95 dB.

Optionally, the ADS is powered by two 3.7V rechargeable batteries, e.g., LiH, with exemplary power ratings of between 2500 mAh and 9000 mAh each for an ADS power of 5000-18,000 mAh. Optionally, other batteries may be employed with similar voltages and/or different voltage and/or different capacities.

Within the embodiments of the invention described above the torch function is described as being turned off and on before/after a discharge. This is to isolate the LEDs or incandescent bulbs etc., of the torch functionality from the high voltage discharge. Within embodiments of the invention this is achieved through control of the ADS to electrical switches. However, within other embodiments of the invention this may be automatically handled via Zener diodes etc. Optionally, within other embodiments of the invention the torch may be powered via a separate circuit to the discharge such that the torch is on during the discharge. This separate circuit may be completely isolated from the discharge circuitry or coupled to it but isolated via diodes, transformers etc.

Optionally, the ADS may be paired with another electronic device, e.g., a FED, PED, wearable device etc. such that the actions of the user with respect to the ADS are communicated to the other electronic device. An application in execution upon the other electronic device may store the action(s) and/or communicate these or those meeting a predetermined condition to a remote server(s), third party etc. via a communications interface of the other electronic device. Accordingly, for example, the predetermined condition may be discharging the electrical discharge such that only in the event of this function being enabled and employed is a notification sent.

Optionally, the ADS may employ one or more biometric sensors to “lock” or “unlock” the ADS so that it can only be used via authorised users whose biometric data is stored within the ADS. Alternatively, the ADS may be unlocked from a software application in execution upon another electronic device, e.g., the user's smartphone, which provides authentication of the user via biometric and/or password means prior to issuing an authentication code to the ADS to release the controls.

Optionally, the user may be able to control aspects of the configuration of the DS, such as number of torch settings, delays before enabling or disabling functions etc. through a software application upon another electronic device which communicates to the ADS via a wired and/or wireless interface.

Optionally, the ADS may store multiple configurations which are enabled through biometric authentication. In this manner, a first user may be able to use the torch functionality only whilst a second user may be able to use the torch and electrical discharge functions.

Optionally, the ADS may employ a positioning system such that the ADS can only be enabled when within a specific area or blocked within a specific area. For example, the ADS may be blocked within a predetermined distance of a town but enabled in the wilderness surrounding the town. Optionally, the ADS may be enabled or disabled based upon the ADS receiving an authentication or enabling code from another device associated with the user which provides the location functionality. For example, a user's smartphone with GPS capability would allow the ADS to be enabled in certain areas and disabled within other areas. Optionally, the areas disabled may be defined by a regulatory authority, e.g., provincial or state police for example, such that hunters can employ the ADS when hunting but not in towns, villages etc. Optionally, the ADS may provide torch functionality in all areas but be limited from providing the discharge functionality by a geofence such that the electrical discharge can only be enabled within the geofence, e.g., within a geofence defining an authorised hunting area for example, or outside the geofence, e.g., enabled when outside the boundary of a town for example.

Optionally, the ADS may include a microphone and/or camera wherein the microphone and/or camera are enabled when the ADS is turned on for example. In this manner the ADS may automatically record information, sounds, images etc. relating to the user of the ADS which may be used by the user of the ADS to address legal issues arising from their use of the ADS. Equally, the lack of stored data relating to an alleged incident may be evidence for the user that the alleged incident did not occur. Optionally, this data may be stored in an encrypted format within the ADS and/or transmitted by the ADS wherein the encryption key for the data is only known to the OEM of the ADS and provided to regulator, legal or law enforcement authorities with the appropriate documentation.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to, portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g., software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. An animal deterrent system comprising:
a body providing a user with a handle at one end and a deterrent element at a second distal end; wherein
the deterrent element comprises:
an optical source as a first deterrent; and
an electrical discharge generator for at least one of generating an acoustic signal as a second deterrent and an electrical discharge into a body of an animal as a third deterrent.

2. The animal deterrent system according to claim 1, wherein
The electrical discharge generator comprises:
an electrical circuit to generate a high voltage between a pair of discharge elements from a low voltage;
the pair of discharge elements disposed on a surface of the second distal end of the body; and
each discharge element of the pair of discharge elements comprises a pair of elongated contacts to penetrate at least one of fur and hair of the animal.

3. 2. The animal deterrent system according to claim 1, wherein
the electrical discharge generator comprises:
an electrical circuit to generate a high voltage between two pairs of discharge elements from a low voltage;
each pair of discharge elements are disposed on a surface of the second distal end of the body;
the two pairs of discharge elements are disposed on opposite sides of the body; and
each discharge element of the pair of discharge elements comprises a pair of elongated contacts to penetrate at least one of fur and hair of the animal.

4. The animal deterrent system according to claim 1, wherein
a user controls the ADS according to the configuration and process flow of FIG. 5.

5. The animal deterrent system according to claim 1, wherein
a user controls the ADS according to the configuration and process flow of FIG. 6.

6. The animal deterrent system according to claim 1, wherein
a user controls the ADS according to the configuration and process flow of FIG. 7.

7. The animal deterrent system according to claim 1, wherein
a user controls the ADS according to the configuration and process flow of FIG. 8.

8. The animal deterrent system according to claim 1, wherein
the body comprises a control circuit for controlling the functionality of the animal deterrent system; and
an ability of the animal deterrent system to generate an electrical discharge is either enabled or disabled with respect to a geofence.

9. The animal deterrent system according to claim 8, wherein
the control circuit determines whether to enable or disable the electrical discharge in dependence upon:
data relating to the geofence stored within a memory of the animal deterrent system; and
location data from a position sensor forming part of the animal deterrent system.

10. The animal deterrent system according to claim 8, wherein
the control circuit is enabled or disabled with respect to the ability to generate the electrical discharge in dependence upon a verification signal received from a further electronic device associated with the animal deterrent system via an interface of the animal deterrent system; and
the further electronic device generates the verification signal in dependence upon:
data relating to the geofence stored within a memory of the further electrical device and location data from a position sensor forming part of the further electrical device.

11. The animal deterrent system according to claim 1, wherein
the body comprises a control circuit for controlling the functionality of the animal deterrent system;
the animal deterrent system at least one of stores and transmits data relating to an event; and
the event is the generation of an electrical discharge by the animal deterrent system.
